(19) United States
(12) Patent Application Publication
(10) Pub. No.: US 2026/0154341 A1
(43) Pub. Date: Jun. 4, 2026

(54) CASE MANAGEMENT METHOD AND CASE MANAGEMENT DEVICE

(71) Applicants: Getac Technology Corporation, Taipei City (TW); WHP Workflow Solutions, Inc., North Charleston, SC (US)

(72) Inventor: Muhammad Adeel, Edina, MN (US)

(21) Appl. No.: 19/380,956

(22) Filed: Nov. 5, 2025

Related U.S. Application Data
(60) Provisional application No. 63/726,632, filed on Dec. 1, 2024.

(51) Int. Cl. G06F 16/901; G06F 16/34

(52) U.S. Cl. CPC G06F 16/9024; G06F 16/345

(57) ABSTRACT

A case management method including steps of providing an incident data, receiving evidence files from a plurality of sources, where each of the evidence files is associated with a metadata; identifying the evidence files based on temporal parameters and spatial parameters, determining a graph structure among the evidence files based on the metadata, where the graph structure includes vertices representing the evidence files and edges representing relationships among the evidence files, and storing the evidence files and the graph structure to an evidence database.

### CROSS-REFERENCE TO RELATED APPLICATIONS

This application claims priority to and the benefits of U.S. Provisional Application No. 63/726,632 filed on Dec. 1, 2024, which is incorporated herein by reference in its entirety.

### TECHNICAL FIELD

The disclosure generally relates to a management method and a management device, and particularly to a case management method and a case management device.

### BACKGROUND

In the big data era, various formats of files are collected from different resources for further analytic processing. The collected files having various formats potentially directed to the same incident; however, the files are not structured data and it is difficult to make decisions on whether the collected files belong to the same incident. Because the collected files are categorized by the user, this manual categorization process wastes time.

Therefore, technologists in the related fields are motivated to find a more efficient and accurate process for case management.

### SUMMARY

The disclosure can be more fully understood by reading the following detailed description of the embodiments, with reference made to the accompanying drawings as described below. It should be noted that the features in the drawings are not necessarily to scale. In fact, the dimensions of the features may be arbitrarily increased or decreased for clarity of discussion.

In some embodiments, a case management method is provided. The case management method includes steps of providing an incident data; receiving evidence files from a plurality of sources, where each of the evidence files is associated with a metadata; identifying the evidence files based on temporal parameters and spatial parameters; determining a graph structure among the evidence files based on the metadata, where the graph structure includes vertices representing the evidence files and edges representing relationships among the evidence files; and storing the evidence files and the graph structure to an evidence database.

In some embodiments, a case management device is provided. The case management device includes a service module, an evidence service module, a search engine, and an evidence database. The service module is configured to provide an incident data. The evidence service module is configured to receive evidence files from a plurality of sources, and each of the evidence files is associated with a metadata. The search engine is configured to identify the evidence files based on temporal parameters and spatial parameters and determine a graph structure among the evidence files based on the metadata, where the graph structure includes vertices representing the evidence files and edges representing relationships among the evidence files. The evidence database is configured to store the evidence files and the graph structure.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as described below. It should be noted that the features in the drawings are not necessarily to scale. In fact, the dimensions of the features may be arbitrarily increased or decreased for clarity of discussion.

FIG. 1 is a block diagram of an example case management device according to some embodiments of the disclosure.

FIG. 2 is a flowchart of an example case management method according to some embodiments of the disclosure.

### DETAILED DESCRIPTION

The specification provides various embodiments to facilitate the implementation of different features of the disclosure. The following descriptions of components and arrangements are illustrated as some aspects of implementations of the disclosure to prevent replication. It should be noted that the embodiments are exemplary and should not be limited herein. For example, technical terms such as “first” and “second” used herein to describe components are merely for distinguishing among the similar to identical elements or operations. The terminology is not intended to limit the technical features of the disclosure, nor to indicate any particular order or priority of operations or steps.

The element symbols or alphabets can be used repeatedly in each embodiment of the disclosure, though, the repeated symbols and alphabets are provided for simplicity and clarity, and they should not be interpreted to limit the relation of the technical terms, nor the order of operations among the embodiments.

The components of the disclosure are described as being “connected,” “coupled,” or “linked,” such terms may refer to electrical connections, electrical coupling, or communicative links. The terms “connected,” “coupled,” or “linked” may also interpret cooperative operations or interactions between or among components.

The technical term “module” indicates programs with algorithms executed by hardware computing components. A module may be a software module including multiple instructions and program codes or a functional module performing operations with a processor. Furthermore, the present disclosure does not limit the connection relationships between modules. Any mechanism between modules, through which a module may obtain necessary data or signals from other modules to perform its operations.

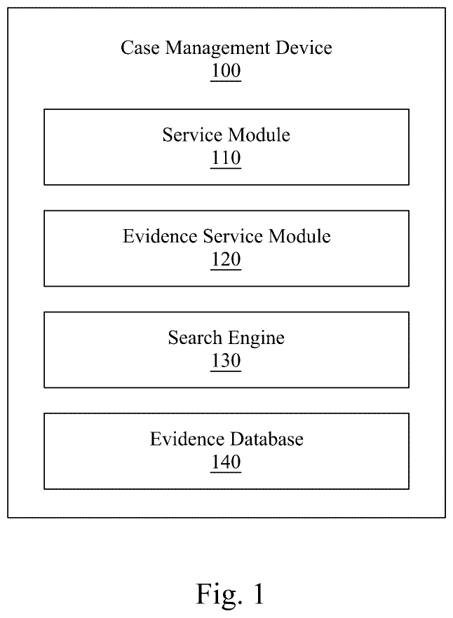

Reference is made to FIG. 1. FIG. 1 is a block diagram of a case management device according to some embodiments of the disclosure.

In some embodiments, the case management device 100 is applied to a computer-aided dispatch (CAD) environment.

As shown in FIG. 1, the case management device 100 includes a service module 110, an evidence service module 120, a search engine 130, and an evidence database 140. In some embodiments, the service module 110, the evidence service module 120, the search engine 130, and the evidence database 140 may interchange data and files with each other.

In some embodiments, the service module 110 is configured to provide an incident data. The incident data includes, but is not limited to, a case identifier, a time information, a location information, and a category.

In some embodiments, the evidence service module 120 is configured to receive evidence files from a plurality of sources, and each of the evidence files is associated with a metadata. The metadata includes, but is not limited to, a timestamp, a GPS data, a user identifier, a badge number, and a case number.

The evidence files may be media files, such as videos, audio recordings, images, and the logs of the media files.

In some embodiments, the search engine 130 is configured to identify the evidence files based on temporal parameters and spatial parameters and determine a graph structure among the metadata. The graph structure includes vertices representing the evidence files and edges representing relationships among the evidence files.

Particularly, the search engine 130 determines a direct evidence relationship between two evidence files when the timestamp and the GPS data overlap for a predetermined threshold. For example, the incident recorded in the evidence file contains the temporal parameter and the spatial parameter. As the time difference between two evidence files is less than the predefined threshold and the locations of occurrence of the evidence files are present in particular places within an area, the timestamp and the GPS data are determined to be overlapped for the predetermined threshold.

The direct evidence relationship between two evidence files indicates that the two evidence files, regarding as the two vertices directly connected with each other of the graph structure, has the direct relationship represented by the edge connecting the two vertices.

Furthermore, the search engine 130 determines an indirect evidence relationship between the evidence files via one or more intermediate files having a direct evidence relationship with the evidence files. The indirect evidence relationship between two evidence files indicates that the two vertices representing the two evidence files are not connected directly though, the two vertices are connected via one or more intermediate vertices. The intermediate files representing the intermediate vertices have a direct evidence relationship.

In some embodiments, the evidence database 140 is configured to store the evidence files and the graph structure.

In some embodiments, the case management device 100 further includes an asset mapping module (not shown in FIG. 1). The asset mapping module is configured to update the evidence relationship among the evidence files when receiving the incident data from the service module 110.

In some embodiments, the case management device 100 further includes a graphical user interface (not shown in FIG. 1). The graphical user interface is configured to visualize the evidence file of a target incident. The evidence files of the target incident include the direct evidence files and the indirect evidence files found by searching through multi-level relationships of the graph structure. Therefore, all of the evidence files associated with the target incident are displayed on the graphical user interface.

In some other embodiments, the graphical user interface is configured to render a case timeline view displaying the evidence files associated with the target incident in a chronological order based on the timestamps. For example, all of the evidence files associated with the target incident are listed or arranged in the time series, so the user may check the evidence easily.

In some other embodiments, the graphical user interface is configured to provide at least one of actions of taking notes of the evidence files, making tags of the evidence files, and making highlights of the evidence files. For example, the user may make some notes on the graphical user interface by inserting the note between the evidence files by the time series.

In some embodiments, the graphical user interface is configured to automatically generate a summary section by aggregating at least one of the notes of the evidence files, the tags of the evidence files, and the highlights of the evidence files.

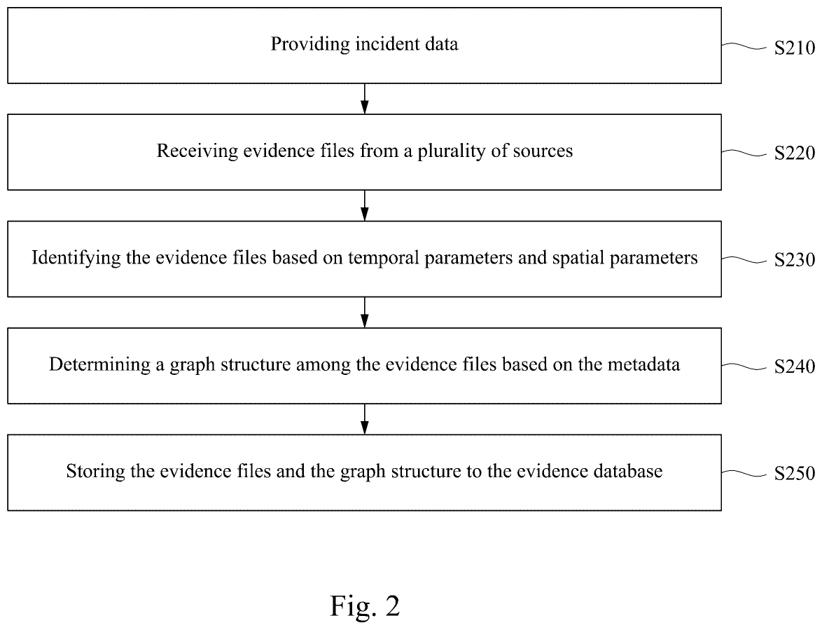

Reference is made to FIG. 2. FIG. 2 is a flowchart of a case management method according to some embodiments of the disclosure.

In some embodiments, the case management method may be implemented by an electronic device including a processor and a storage medium. In some embodiments, the case management method may be implemented by the case management device illustrated in FIG. 1.

In step S210, providing incident data by the service module 110 is performed.

In some embodiments, the incident data includes a case identifier, time information, location information, and a category. For example, one incident is regarded as one case established in the database. The case identifier may be a serial number of the case. The time information may be the time the incident happened. The location may be places, buildings, addresses, and so on, the incident happened. The category may be types or groups the incident associated. The category may be predefined by the service module 110.

In step S220, receiving evidence files from a plurality of sources by the evidence service module 120 is performed.

In some embodiments, the plurality of sources may be data from cameras (such as in-car cameras or body worn cameras), personal electronic devices, or uploaded by multiple users. The evidence files may be stored in formats, such as images, audio, video files, and so on.

In some embodiments, each of the evidence files is associated with a metadata. The metadata includes at least one of a timestamp, a GPS data, a user identifier, a badge number, and a case number.

In step S230, identifying the evidence files based on temporal parameters and spatial parameters by the search engine 130 is performed.

For example, the GPS data and timestamp indicate that two evidence files are collected at the same location within a specific overlapping time period according to a preset or customized time and distance threshold (e.g., the evidence files are collected in a 10-minute period and in 1 mile radius). For another example, if the two files are not collected by the same source, the relationship between the evidence files may be created based on the same personnel, the same case number, or the related CAD number.

In step S240, determining a graph structure among the evidence files based on the metadata by the search engine 130 is performed.

In the graph structure, the evidence files are regarded as the vertices, and the relationships between the evidence files are regarded as the edges between the vertices. That is, the edge indicates the direct evidence relationship, and the second or more level indicates the indirect evidence relationship. The level of the evidence files may be used to categorize the evidence file. That is, whether the evidence files belong to the same incident may be determined.

The graph structure includes direct evidence relationships and indirect evidence relationships. In some embodiments, the direct evidence relationship between two evidence files is determined when the timestamp and the GPS data of two evidence files overlap for a predefined threshold. In some other embodiments, the indirect evidence relationship between two evidence files is determined via one or more intermediate files having a direct evidence relationship with the two evidence files.

For example, a first evidence file relates to a second evidence file, and the second evidence file relates to a third evidence file. In this case, the first evidence file and the second evidence file have a direct evidence relationship. On the other hand, the first evidence file and the third evidence file have the indirect evidence relationship (or called “the second level relationship”).

The accuracy of the direct evidence relationship and the indirect evidence relationship is maintained based on the overlapping time information, the GPS accuracy, and other related factors. The graph structure facilitates identifications of the evidence relationships even though the evidence files are related to an open case, and it is possible to lead to resolution.

In step S250, storing the evidence files and the graph structure to the evidence database 140 is performed.

In some embodiments, the evidence database 140 stores the evidence files and the graph structure containing the vertices and the edges among the vertices.

In some embodiments, the case management method further includes steps of visualizing the evidence files of a target incident by a graphical user interface. The evidence files of the target incident include the direct evidence files and the indirect evidence files found by searching through multi-level relationships of the graph structure.

In some embodiments, the case management method further includes steps of rendering a case timeline view displaying the evidence files associated with the target incident in a chronological order based on the timestamp by the graphical user interface. The case timeline provides the user to review or take actions including taking notes on the evidence files, making tags on the evidence files, and making highlights of the evidence files.

In some embodiments, the case management method further includes steps of automatically generating a summary section by aggregating at least one of the notes of the evidence files, the tags of the evidence files, and the highlights of the evidence files.

In some embodiments, the case management method further includes steps of updating the relationships among the evidence files by the asset mapping module when receiving the incident data by the service module 110.

Accordingly, the case management device and the case management method mentioned in the present disclosure associate the related records from the plurality of sources, so as to reduce time spent recalling files and classifying incidents. The stored resources associated with the same incident can be identified and viewed together in the graphical user interface. Therefore, the proposed device and method provide improved efficiency to analysts and command staff, resulting in a more efficient and accurate case management and investigation.

It will be apparent to those skilled in the art that various modifications and variations can be made to the structure of the present disclosure without departing from the scope or spirit of the present disclosure. In view of the foregoing, it is intended that the present disclosure covers modifications and variations of the present disclosure provided they fall within the scope of the following claims.

What is claimed is:

1. A case management method, comprising:
providing an incident data;
receiving evidence files from a plurality of sources, wherein each of the evidence files is associated with a metadata;
identifying the evidence files based on temporal parameters and spatial parameters;
determining a graph structure among the evidence files based on the metadata, wherein the graph structure comprises vertices representing the evidence files and edges representing relationships among the evidence files; and
storing the evidence files and the graph structure to an evidence database.

2. The case management method of claim 1, wherein the incident data comprises at least one of a case identifier, time information, location information, or a category.

3. The case management method of claim 1, wherein the metadata comprises at least one of a timestamp, a GPS data, a user identifier, a badge number, or a case number.

4. The case management method of claim 3, wherein determining the graph structure among the evidence files based on the metadata further comprises:
determining a direct evidence relationship between two of the evidence files when the timestamp and the GPS data of the two of the evidence files overlap for a predefined threshold.

5. The case management method of claim 4, wherein determining the graph structure among the evidence files based on the metadata further comprises:
determining an indirect evidence relationship between two of the evidence files via one or more intermediate files having the direct evidence relationship with the two of the evidence files.

6. The case management method of claim 5, further comprising:
visualizing the evidence files of a target incident by a graphical user interface, wherein the evidence files of the target incident comprise direct evidence files and indirect evidence files found by searching through multi-level relationships of the graph structure.

7. The case management method of claim 6, wherein visualizing the evidence files of the target incident further comprises:
rendering a case timeline view displaying the evidence files associated with the target incident in a chronological order based on the timestamp by the graphical user interface.

8. The case management method of claim 6, further comprises:
providing at least one of actions of taking notes on the evidence files, making tags of the evidence files, or making highlights of the evidence files.

9. The case management method of claim 8, further comprising:
automatically generating a summary section by aggregating at least one of the notes of the evidence files, the tags of the evidence files, or the highlights of the evidence files.

10. The case management method of claim 1, further comprising:
updating the relationships among the evidence files when receiving the incident data.

11. A case management device, comprising:
a service module configured to provide an incident data;
an evidence service module configured to receive evidence files from a plurality of sources, and each of the evidence files is associated with a metadata;
a search engine configured to identify the evidence files based on temporal parameters and spatial parameters and determine a graph structure among the evidence files based on the metadata, wherein the graph structure comprises vertices representing the evidence files and edges representing relationships among the evidence files; and
an evidence database configured to store the evidence files and the graph structure.

12. The case management device of claim 11, wherein the incident data comprises at least one of a case identifier, a time information, a location information, or a category.

13. The case management device of claim 11, wherein the metadata comprises at least one of a timestamp, a GPS data, a user identifier, a badge number, or a case number.

14. The case management device of claim 13, wherein the search engine is configured to determine the graph structure among the evidence files based on the metadata by:
determining a direct evidence relationship between two of the evidence files when the timestamp and the GPS data of the two of the evidence files overlap for a predefined threshold.

15. The case management device of claim 14, wherein the search engine is configured to determine the graph structure among the evidence files based on the metadata by:
determining an indirect evidence relationship between two of the evidence files via one or more intermediate files having the direct evidence relationship with the two of the evidence files.

16. The case management device of claim 15, further comprising:
a graphical user interface configured to visualize the evidence files of a target incident, wherein the evidence files of the target incident comprise direct evidence files and indirect evidence files found by searching through multi-level relationships of the graph structure.

17. The case management device of claim 16, wherein the graphical user interface is further configured to render a case timeline view displaying the evidence files associated with the target incident in a chronological order based on the timestamp.

18. The case management device of claim 16, wherein the graphical user interface is further configured to provide at least one of actions of taking notes of the evidence files, making tags of the evidence files, or making highlights of the evidence files.

19. The case management device of claim 18, wherein the graphical user interface is further configured to automatically generate a summary section by aggregating at least one of the notes of the evidence files, the tags of the evidence files, or the highlights of the evidence files.

20. The case management device of claim 11, further comprising:
an asset mapping module configured to update the relationships among the evidence files when receiving the incident data from the service module.
